(19) United States
(12) Patent Application Publication
(10) Pub. No.: US 2004/0050929 A1
(43) Pub. Date: Mar. 18, 2004

(54) Extranet security system and method

(76) Inventor: Robert W. Fayfield, Excelsior, MN (US)

Correspondence Address: MERCHANT & GOULD PC, P.O. BOX 2903, MINNEAPOLIS, MN, 55402-0903, US

(21) Appl. No.: 10/245,076

(22) Filed: Sep. 16, 2002

(51) Int. Cl. G06K 5/00

(52) U.S. Cl. 235/380

(57) ABSTRACT

A method of providing Extranet security to prevent unauthorized access to an Extranet site. The method comprises transmitting an introductory web page from an Extranet server to a user requesting access to the secure Extranet site, wherein at least one user-data input field is provided on the web page prompting the user to enter their credit card number within the at least one user-data input field and transmitting the user-credit card number to an Extranet server which provides the credit card number to a security module, wherein the security module maintains a database of each of a plurality of predetermined authorized, user-credit card numbers. The method further comprises verifying whether the submitted user credit card number is one of the plurality of predetermined authorized, user-credit card numbers, wherein said verifying step comprises comparing the user-credit card number with each of the plurality of predetermined authorized, user-credit card numbers and granting the user access to the secure Extranet site when a positive verification results from said verifying step, wherein an undesired output results in denial of access to said secure Extranet site.

### TECHNICAL FIELD

The field of the invention is systems that provide heightened security access to restricted web-sites that use the public internet as its transmission system, and methods thereof; in particular, this invention relates to improved systems and methods for providing Extranet security where there is a need to prevent unauthorized access.

### BACKGROUND

The increase in e-commerce has created a need to process electronic payments for goods and services to customers via merchant websites over the Internet. With the dramatic increase in this business activity, existing industries sought ways to provide a mechanism to process electronic payments to facilitate the sale of these goods and services. Thus, financial service providers have constructed systems to process credit card charges and systems to pay electronic check transactions.

In addition to their web-sites, most companies now maintain an “Extranet” for information exchange within the company and throughout the sales and distribution channel. Much of the content for these sites is highly confidential, for example in the use of a “Customer Relationship Management” (CRM) system, which allows company sales personnel and distributors to share information about customers, including quotations, key customer staff members, programs, plant locations technical and product information and the like.

Currently, most of these confidential sites rely on passwords to prevent unauthorized people from getting at the information. One problem is that, with hundreds or even thousands of potential authorized-users, the Extranet-providing company often does not know when a person has left the employment of the authorized sales organization or distribution channel member. In addition, users are notorious for telling others their password. A distributor sales person might, for example, tell his customer the password so the customer can get at a training program that was intended only for authorized-users. This makes it difficult for companies to put non-professional information on the Extranet, such as informal video training clips, for fear that a customer will view the site and feel that it lacks “class” or falls below expected levels of professionalism. Another point of concern is that a customer might then give the password for the host company's Extranet to a competitor of the host company, innocently asking the competitor to comment on some portion of it.

The root cause of the problem is that there is nothing risky for the authorized-user in giving out their password. What is needed is a password that exposes the user to risk if they give the password to just anyone, but does not cause a risk if the host company knows the password.

### SUMMARY

One embodiment of the present invention provides a method of providing Extranet security to prevent unauthorized access to Extranet site. The method involves transmitting an introductory web page from an Extranet server to a user requesting access to the secure Extranet site. At least one user-data input field is provided on the web page, prompting the user to enter their credit card number within the at least one user-data input field. The method still further involves transmitting the user-credit card number to an Extranet server which provides the credit card number to a security module. The security module maintains a database of each of a plurality of predetermined authorized, user-credit card numbers. The method further involves verifying whether the submitted user credit card number is one of the plurality of pre-determined authorized, user-credit card numbers. This verifying step involves comparing the user-credit card number with each of plurality of predetermined authorized, user-credit card numbers. The method involves granting the user access to the secure Extranet site when a positive verification results from the verifying step. On the other hand, the method provides that if an undesired output results, the user is denied access to the secure Extranet site.

Another embodiment of the present invention provides that the security module is maintained on the Extranet server. An another embodiment of the present invention the method further involves verifying that each of the at least one input field contains data, wherein further if data is omitted from the at least one input field then a message indicated the omission is communicated to the user. According to yet another embodiment of the present invention, the method involves tracking a level of access clearance associated with the authorized, user-credit card number. According to yet another embodiment of the present invention, the granting step further comprises of logging in the user to the Extranet site with the level of access clearance associated with the user-credit card number.

One embodiment of the present invention provides a method for providing heightened security to an Extranet site, thereby preventing unauthorized access. The method involves transmitting, over an electronic medium, an introductory web page from an Extranet server to a user requesting access to an Extranet site. The method further involves prompting the user to enter requested personal information within the at least one user-data input field, wherein said personal information includes the users credit card related data. The method also involves transmitting the personal information provided by the user to a restricted web-site providers' transactions security-processing server. The server maintains a database of characteristics personal information uniquely associated with each of a plurality pre-determined authorized users. The characteristic personal information includes each of a plurality of predetermined authorized-users' credit card related data. The method still further involves analyzing the personal information in view of the characteristic personal information uniquely associated with each of the plurality of predetermined authorized-users', and granting access to a secure Extranet site when a desired output results from said analyzing step, wherein an undesired output results in denial of access to said secured Extranet site.

Another embodiment of the present invention, the method involves transmitting over an electronic medium the introductory web page is transmitted over an Internet. An yet another embodiment of the present invention, the plurality of predetermined authorized-users' credit card related data includes a credit card number. In yet another embodiment of the present invention the method further involves verifying that each of the at least one input field contains data. If data is omitted from the at least one input field then a message indicating the omission is communicated to the user. In another embodiment of the present invention the method involves tracking a level of access clearance associated with the user credit card number. After granting access to the user, the method further involves logging in the authorized-user into the Extranet site, with the level of access clearance associated with the user credit card number.

One embodiment of the present invention provides an Extranet security system for prevention unauthorized-users from gaining access to restricted web sites. The Extranet security system is maintained on an Extranet server. The server includes a user interface module, and Extranet request processing module, coupled to the user interface module. This Extranet request processing module generates an introductory web page, that provides at least one input field, and prompts a user to provide at least a user credit card number. This system further includes a credit card verification module, coupled to the Extranet request processing module, which communicates the user credit card number to a third party support server. Within the third party support server the user credit card number is processed and compared against an authorized-user credit card database maintained within that server. The results of the processing are communicated to the credit card verification module. If the comparison yields a desired output, then the credit card module grants the user access to a secured Extranet, otherwise, user access is denied. The system also includes an Extranet interface module coupled to the credit card module. After the credit card verification module grants user access, the user engages the Extranet provider database through Extranet interface module.

Another embodiment of the present invention provides an Extranet request processing module that verifies each of the at least one input field contains data. If data is omitted the at least one input field then a message indicating the omission is communicated to the user. In yet another embodiment of the present invention, the system further includes a rejected credit card tracking database, coupled to the credit card verification module, for storing rejected credit card numbers. In yet another embodiment of the present invention, the system further includes a clearance level identification and association module, coupled to the credit card data verification module and the Extranet interface module. The clearance level identification an association module tracks the level of access clearance associated with each authorized-user provided credit card number and communicates that level of access clearance to the credit card verification module. This module also logs in the authorized-user within the secured Extranet in view of the level of access clearance associated with the user provided credit card number.

### BRIEF DESCRIPTION OF THE DRAWINGS

FIG. 1 illustrates a high level data flow diagram of an Extranet security system according to the present invention.

FIG. 2a illustrates an Extranet security system according to the present invention.

FIG. 2b illustrates an Extranet security system according to another exemplary embodiment of the present invention.

FIG. 3 illustrates a general purpose computing system that may be used as part of an Internet-based financial payment processing system according to one embodiment of the present invention.

FIG. 4 illustrates another embodiment an embedded-Extranet security system, according to the present invention, operating in an Internet-based e-commerce processing system.

FIG. 5 illustrates a portion of an exemplary, introduction web-page, with input fields, that is provided in an embodiment of an Extranet security system according to the present invention.

FIG. 6 illustrates an operational flow for one embodiment of an Extranet security system, according to the present invention.

FIG. 7 illustrates an operational flow diagram from a client PC perspective according to the present invention.

FIG. 8 illustrates an operational flow diagram from an Extranet server perspective, according to the present invention.

### DETAILED DESCRIPTION

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention.

The present invention provides a system and a method to provide improved Extranet access security utilizing a user's valid and current credit card number as a password for a restricted web-site, particularly for an Extranet site where there is a need to prevent unauthorized sharing of a password. This might normally be thought to carry its own risk, however, the present invention provides a solution that resolves many of the problems, discussed above, currently facing companies that operate Extranet sites while providing several advantages over current alternatives. For example, since it is quite common for distributors, representatives, and other “insiders” to purchase products from e-commerce sites, Extranet providers will be able to offer the convenience of allowing these same users to access an Extranet to gain access to information without the hassle of providing a new password. Concurrently, the Extranet provider will still enjoying increased protection of the information on its restricted sites. Furthermore, since because many companies in industry often already process credit cards utilizing a “hands-off” method to automatically verify the validity of a credit card, the user and/or the user's host-company employer still enjoy the customary level of protection from credit card fraud.

A further advantage to the user is that they always have the password with them, since they always carry the credit card. Of course once they are logged on they can also purchase any items without further effort, much like any e-commerce site that already has your credit and billing and shipping information.

The present invention provides improved restricted web-site or Extranet security. After all, it is human nature to keep your credit card related information (e.g. the credit card number) secret. It is not very likely that a user would write this information down or share it with others, as is a shortcoming of many current restricted-web-site security systems and methods. Thus, the present invention provides an Extranet provider with decreased chance of experiencing non-authorized users accessing its Extranet information.

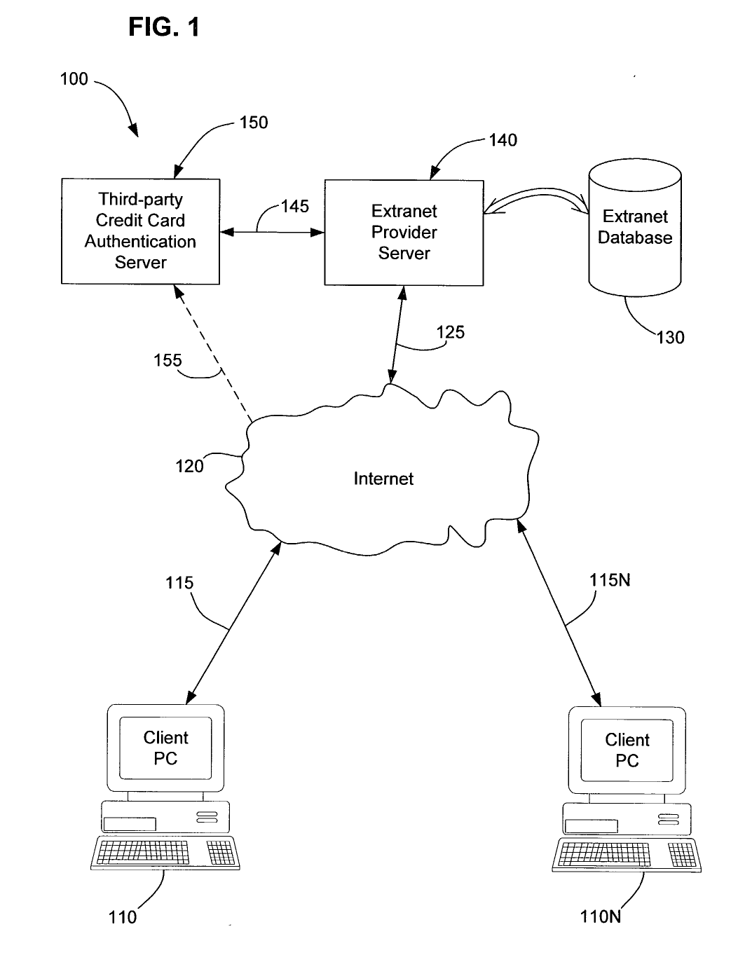

FIG. 1 illustrates a high level data flow diagram 100 of an Extranet security system according to the present invention. The Extranet security system is maintained on the Extranet server 140. Generally, the Extranet security system operates in an environment similar to the one show in FIG. 1 which includes a plurality of Client PCs 110-110ₙ, a Third Party Credit Card Authorization server 150, an Extranet server 140, an Extranet database 130 all communicatively connected to the Internet 120. As shown, a Client PC 110-110ₙ, is connected to the Internet 120 by communicative connection 115-115ₙ. The Client PC 110-110ₙ sends an access request transmission over the Internet 120, or some other communication means, to the Extranet server 140, which is connected to the Internet 120 by communicative connection 125. The access request transmission includes the Client PC 110-110ₙ user's credit card number. Once the Extranet server 140 receives the user's credit card number it communicates over communicative connection 145 with The Third Party Credit Card Authorization server 150 to transmit the user's credit card number along with a request to verify that this credit card number positively compares with an authorized, member credit card number. Accordingly, the third party credit card authorization server 150 analyzes the user's credit card number and transmits back to the Extranet server 140 the results of that analysis. The results of the analysis are evaluated by the Extranet server 140 to discern whether the tendered credit card number is or is not an authorized, member credit card number. If the evaluation of the results yield a positive authentication of the credit card number, then the Extranet server 140 grants the client PC 110-100ₙ use of the communicative connection 135 to access the information maintained on the Extranet database 130. If, on the other hand, the results of the analysis yield a negative response, then the Extranet server 140 transmits a denial signal over the Internet 120 to the client PC 110-110ₙ, thus notifying the user that access has been denied. In another embodiment of the present Extranet security system, the client PC 110-110ₙ transmits an access request and the user's credit card number over the Internet 120, but thereafter the access request is transmitted to the Extranet server 140 and the third party credit card authentication server also receives the credit card number directly over data line 155 (shown in dotted line in FIG. 1). The data flow is otherwise the same as discussed above.

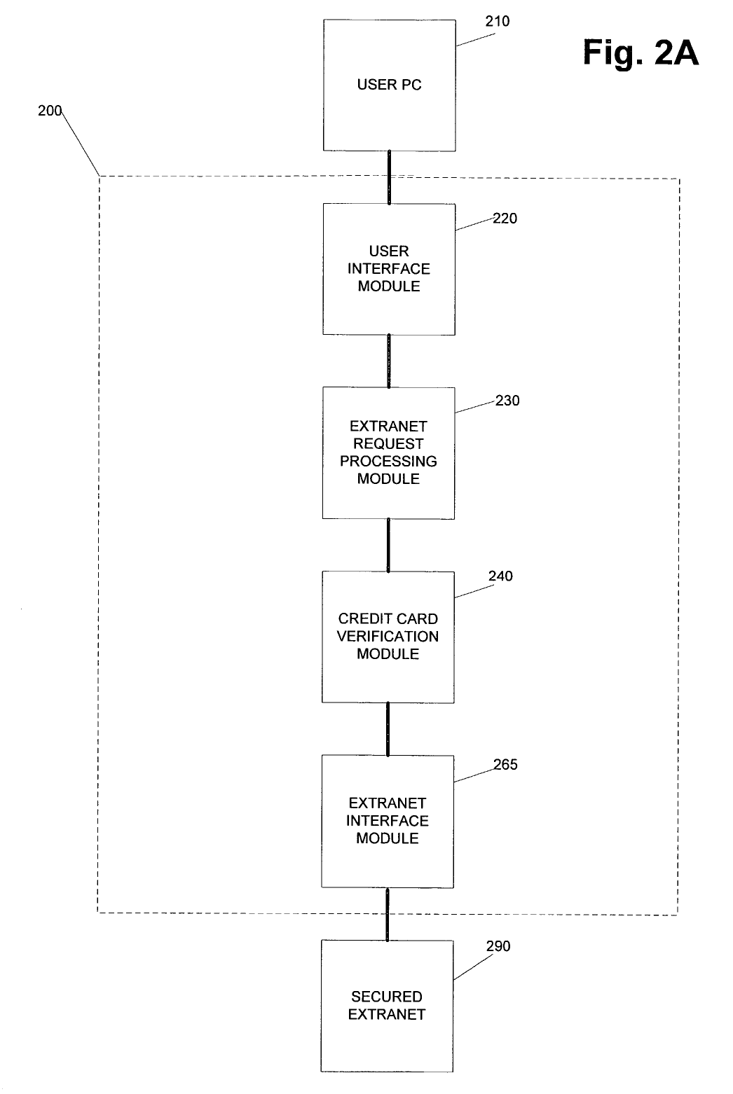

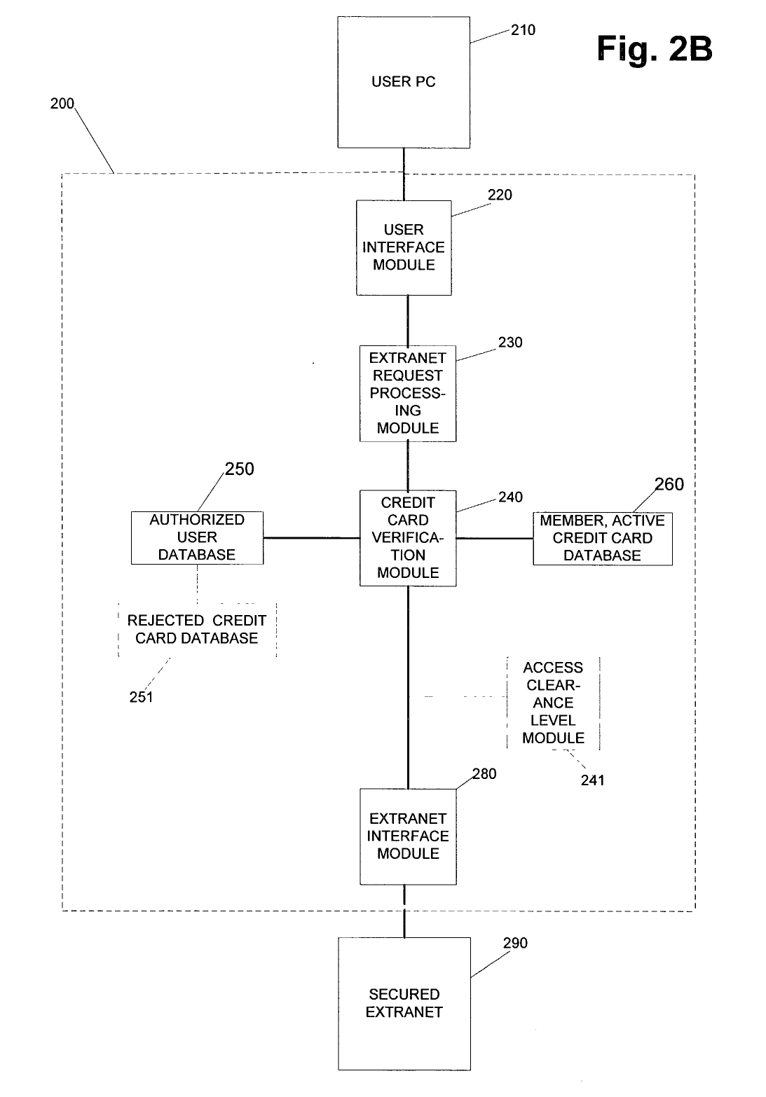

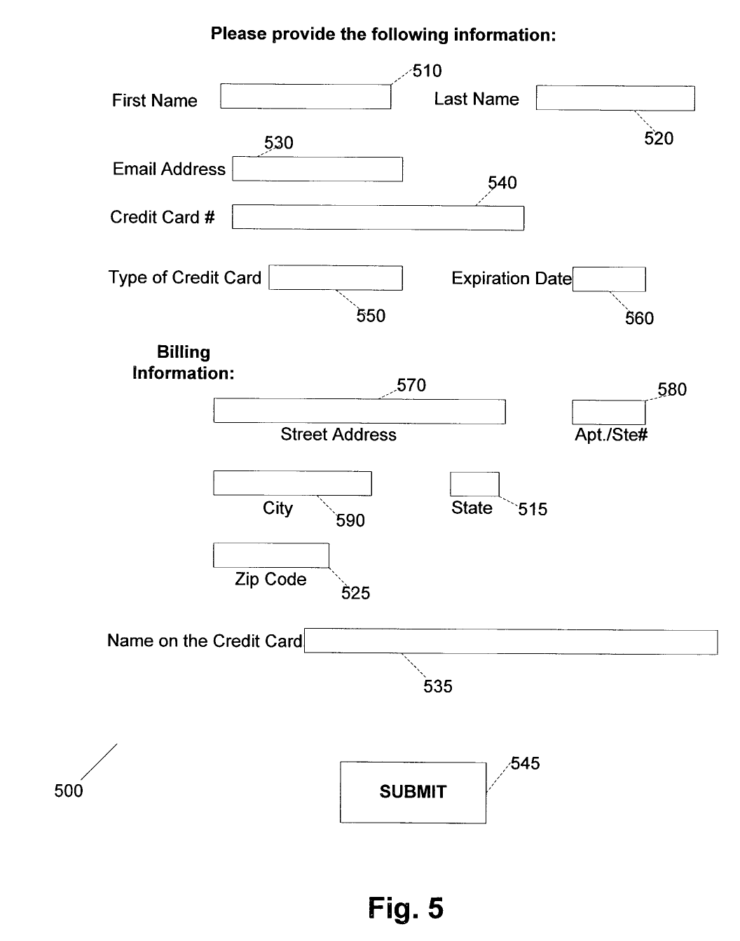

FIG. 2a illustrates 200 an Extranet security system according to the present invention. Once on the Internet, a user would attempt to assess the host's secured Extranet 290, but to do so the user must be granted access by the Extranet security system 200. From the user PC, or client server, 210 the user communicates over the Internet with the Extranet server, and therein engages several modules including the user interface module 220. The user interface module 220 allows the client server 210 to interact with the Extranet request processing module 230, that is maintained on Extranet server. The Extranet request processing module 230 will generate an introduction web page that is displayed on the user/client PC 210. The introductory web page will provide at least one input field, and prompt the user to provide the information requested in each of the at least one input field provided on the introductory web page. The input fields provided on the introductory web-page can include a field requesting the user's credit card number, the user's first and last name, the credit card's expiration date, and the user's billing address and other related billing information. In another embodiment of the present invention, there would be provided only one input field and the user would be prompted to provide just the credit card number. The introductory web page would provide an enter or submit button that could be actuated by the user through his or her mouse, keyboard or other input device connected to the user PC 210, after the user has completed providing the requested information in the input fields provided on the introductory web-page. More discussion of an exemplary introductory web-page is provided below with regard to FIG. 5.

In one embodiment of the present invention, the Extranet request processing module 230 internally verifies that each of the at least one input field contains the appropriate formatted data (e.g., where the user indicates the credit card number submitted corresponds to a VISA® then the Extranet request processing module 230 will verify that the credit card number provided has the correct number of digits corresponding to standard VISA® format.). If the Extranet request processing module 230 finds that data has been omitted from the at least one input field or that the data in the input field is of the incorrect size or format, then the Extranet request processing module 230 will generate another web page where a message indicating the omission or error is displayed on the user PC 210, and the user is prompted to reenter the proper information. Once the user provided credit card number is accepted by the Extranet request processing module 230 this information is transmitted to the credit card data verification module 240, which in this embodiment also resides on the Extranet server. Authorized-user credit card numbers are stored in an authorized-user credit card database maintained within the credit card data verification module 240. The credit card verification module 240 communicates with an authorized-user credit card database which is maintained on the Extranet server, in processing the user's access request. More specifically, the user credit card number is processed and compared against the data maintained in the authorized-user credit card database, and if the comparison yields a desired output then the user is granted access to a secured Extranet 290. Otherwise, the user access request is denied.

In another embodiment of the present invention, the credit card verification module 240 also maintains a rejected credit card tracking database. In this embodiment, the credit card verification module 240 processes and compares the user's provided credit card number against those credit card numbers maintained in the rejected credit card tracking database, and if a match is not found, the credit card verification module 240 then processes and compares the user provided credit card number against the authorized-user credit card database. In yet another embodiment of the present invention, after the credit card verification module 240 grants the user's access request, the module 240 logs in the authorized-user with the secured Extranet 290.

In yet another embodiment of the present invention, the credit card verification module 240 tracks the level of access clearance associated with each authorized-user provided credit card number, and where the credit card verification module 240 also logs in the authorized-user after the granting of access, the credit card verification module will further log in the authorized-user in view of this level of access clearance associated with the user provided credit card number.

In another embodiment of the present invention, the credit card verification module 240 is maintained on an external third-party server (e.g., a Credit Card Supplier Server). However, in this alternate embodiment, the module 240 does not track the level of access clearance associated with a given authorized credit card number or in authorized users after access rights have been verified. Instead, an Access Level Monitoring module (not shown in the figures) would provide this functionality to the Extranet server.

In further regard to the credit card verification module 240 shown in FIG. 2, an authorized-user credit card database is maintained and supported by the restricted web-site, or Extranet server. While in another embodiment, the authorized-user database is automatically updated by the credit card verification module 240 each time a user attempts to access the restricted web-site. In other words, it is authorized-user data that is removed or added from the Extranet server maintained credit card verification module 240 as a function of, and responsive to, the results of the credit card verification module's 240 analysis.

Once the credit card verification module 240 grants access to the user, the user PC 210 is allowed to communicate with the secured Extranet 290, through the Extranet interface module 265.

FIG. 2a illustrates an Extranet security system 200 according to another exemplary embodiment of the present invention. In order to engage the secured Extranet 290, the user PC 210 must be granted access by the Extranet security system 200. The Extranet security system 200 includes a user interface module 220, an Extranet request processing module 230, a credit card verification module 240, an authorized-user database 250, a member, active credit card database 275, and an Extranet interface module 265. Each of these modules can be maintained on the Extranet server. In another embodiment, however, the credit card verification module 240 is maintained and the member, active credit card database 275 are maintained on external servers. In yet another exemplary embodiment, the member, active credit card database 275 is maintained on an Authorized Member server (not shown in figures) that is maintained by client companies that are authorized to access Extranet information. In yet another exemplary embodiment, the credit card verification module 240 is maintained on a Credit Card Supplier's server (not shown in figures).

The member, active credit card database 275 maintains a list of issued, active credit card information associated with a member organization's employees or agents. The list of issued, active credit card information includes a list of active credit card numbers issued to each or the member organizations employees or agents, and this data is provided to the credit card verification module 240 and it uses this data in its analysis of the current user provided credit card number. The authorized-user database 250 maintains current authorized-user data, which includes current authorized-user credit card numbers. Upon receiving the current user provided credit card information, which includes the user credit card number, the credit card verification module 240 analyzes the user provided credit card number in view of the list of issued, active credit card information that is communicated from the member, active credit card database 275, and the authorized-user data, communicated from the authorized-user database 250. In an alternative embodiment of the present invention, an Extranet security system 200 uses the credit information data from an external active credit card tracking database, such as one maintained by the issuing credit card company, in this analysis instead of, or in conjunction with, the member, active credit card database 275. If, the credit card verification modules 240 analysis yields a desired output then the user request is granted, and the user will be allowed access to the restricted web-site. Otherwise, user access is denied. Once access has been granted, the user PC 210 is allowed to communicate through the Extranet interface module 265 with the secured Extranet 290.

FIG. 2b also illustrates one implementation of an independent rejected credit card database 251 in an Extranet security system 200, according to the present invention. The independent rejected credit card database 251 shown is not maintained on the Extranet server. In this illustration, the database 251 is maintained externally on the Third-Party server, thus the independent rejected credit card database 251 is shown in a dashed-line format to distinguish it as external to the Extranet provider's server. However, in another embodiment (not shown), the database 251 is maintained on the Extranet server. The data maintained on the database 251 can also be shared with the authorized sales organization, distribution channel members, or other employer members for their internal security and control mechanisms. In one embodiment, this database can be used by the credit card data verification module 240 in evaluating requests. For example, any attempts by a user to use a bad account number in the host's rejected credit card database 251 will result in a declined transaction or declined request for access. Hosts can add account numbers to the rejected credit card database 251 at their discretion, or the Extranet security module 200 can be configured to automatically update this database 251 contemporaneous to each access request.

Generally, one skilled in the art can appreciate, that the process discussed above is substantially identical to the process used to buy good and services over the Internet. Thus, an Extranet provider utilizing are Extranet Security System according to the present invention enjoys the convince of conducting standard electric commerce and increased Extranet database protection in the same system.

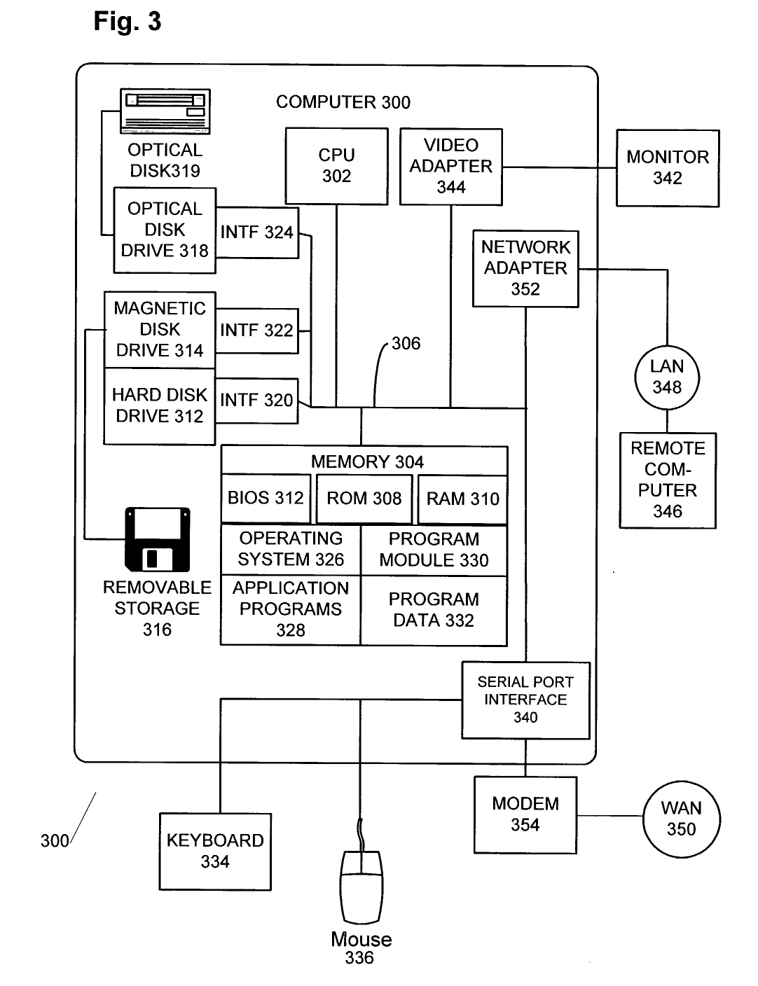

FIG. 3 illustrates a general purpose computing system 300 that may be used as part of an Internet-based Extranet security system, according to one embodiment of the present invention. An exemplary computing system for embodiments of the invention includes a general purpose computing device in the form of a conventional computer system 300, including a processor unit 302, a system memory 304, and a system bus 306 that couples various system components including the system memory 304 to the processor unit 300. The system bus 306 may be any of several types of bus structures including a memory bus or memory controller, a peripheral bus and a local bus using any of a variety of bus architectures. The system memory includes read only memory (ROM) 308 and random access memory (RAM) 310. A basic input/output system 312 (BIOS), which contains basic routines that help transfer information between elements within the computer system 300, is stored in ROM 308.

The computer system 300 further includes a hard disk drive 312 for reading from and writing to a hard disk, a magnetic disk drive 314 for reading from or writing to a removable magnetic disk 316, and an optical disk drive 318 for reading from or writing to a removable optical disk 319 such as a CD ROM, DVD, or other optical media. The hard disk drive 312, magnetic disk drive 314, and optical disk drive 318 are connected to the system bus 306 by a hard disk drive interface 320, a magnetic disk drive interface 322, and an optical drive interface 324, respectively. The drives and their associated computer-readable media provide nonvolatile storage of computer readable instructions, data structures, programs, and other data for the computer system 300.

Although the exemplary environment described herein employs a hard disk, a removable magnetic disk 316, and a removable optical disk 319, other types of computer-readable media capable of storing data can be used in the exemplary system. Examples of these other types of computer-readable mediums that can be used in the exemplary operating environment include magnetic cassettes, flash memory cards, digital video disks, Bernoulli cartridges, random access memories (RAMs), and read only memories (ROMs).

A number of program modules may be stored on the hard disk, magnetic disk 316, optical disk 319, ROM 308 or RAM 310, including an operating system 326, one or more application programs 328, other program modules 330, and program data 332. A user may enter commands and information into the computer system 300 through input devices such as a keyboard 334 and mouse 336 or other pointing device. Examples of other input devices may include a microphone, joystick, game pad, satellite dish, and scanner. These and other input devices are often connected to the processing unit 302 through a serial port interface 340 that is coupled to the system bus 306. Nevertheless, these input devices also may be connected by other interfaces, such as a parallel port, game port, or a universal serial bus (USB). A monitor 342 or other type of display device is also connected to the system bus 306 via an interface, such as a video adapter 344. In addition to the monitor 342, computer systems typically include other peripheral output devices (not shown), such as speakers and printers.

The computer system 300 may operate in a networked environment using logical connections to one or more remote computers, such as a remote computer 346. The remote computer 346 may be a computer system, a server, a router, a network PC, a peer device or other common network node, and typically includes many or all of the elements described above relative to the computer system 300. The network connections include a local area network (LAN) 348 and a wide area network (WAN) 350. Such networking environments are commonplace in offices, enterprise-wide computer networks, intranets, and the Internet.

When used in a LAN networking environment, the computer system 300 is connected to the local network 348 through a network interface or adapter 352. When used in a WAN networking environment, the computer system 300 typically includes a modem 354 or other means for establishing communications over the wide area network 350, such as the Internet. The modem 354, which may be internal or external, is connected to the system bus 306 via the serial port interface 340. In a networked environment, program modules depicted relative to the computer system 300, or portions thereof, may be stored in the remote memory storage device. It will be appreciated that the network connections shown are exemplary, and, other means of establishing a communications link between the computers may be used.

The embodiments of the invention described herein are implemented as logical operations in a telecommunications system having connections to a distributed network such as the Internet. The logical operations are implemented (1) as a sequence of computer implemented steps running on a computer system and (2) as interconnected machine modules running within the computing system. The implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto.

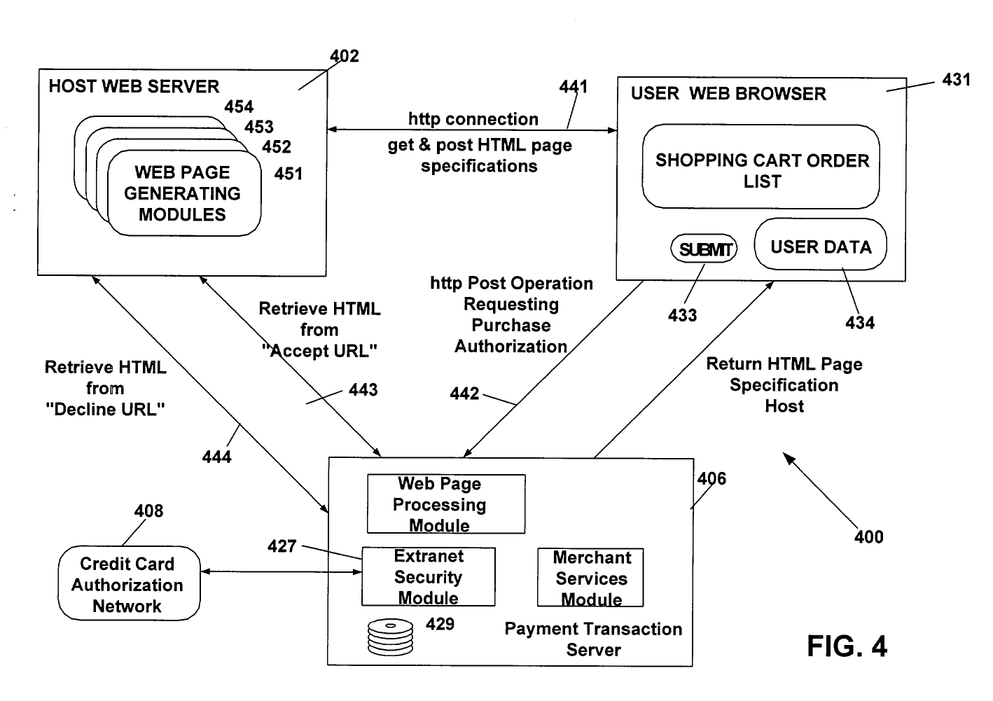

FIG. 4 illustrates an embodiment of an embedded-Extranet security module 427, according to the present invention, operating in an Internet-based e-commerce processing system 400. The e-commerce processing system includes a host web server 402 and a secured transaction server 406, that are working together to process orders for goods and services. The secured transaction server 406 processes requests to access a secured Extranet site or database 429 from a user's personal computer over the Internet 407. Using a web browser 431, the user interacts with the host web server 402 using an http connection over the Internet 441 to request access to the secured Extranet site or database 429, and to place an order for goods. The host web server 402 could include one or more web page generating modules 451-454 to provide the web pages on the user web browser 431 that are needed to receive user data 434, which includes the user's credit card number, for secured access request and, for example, to create a shopping cart 411.

It can be appreciated by one skilled in the art, that there is a multitude of methods for implementing an Internet-based e-commerce system 400, and a detailed discussion of that portion of this system's 400 functionality, or a corresponding process, is not necessary here. Thus, henceforth the discussion of the system shown in FIG. 4 will focus on the processing of requests for access to an Extranet site, provided by a host-merchant, that is secured by a system (i.e., the embedded-Extranet security module 427), according to the present invention.

When an access request is complete (i.e., all required input fields, which includes the user credit card number, provided on an Extranet introduction page), the user may click on a Submit button 433 on a web page to submit the request containing user data 434, which includes at least a user credit card number, for use in deciding whether to grant access to the secured web-site. The Submit button 433 includes processing instructions which cause the request to be submitted to the secured transaction server 406 using an appropriate URL for the server 406. An http Submit operation 442 may be used to send an access authorization request to the Secured Transaction server 406.

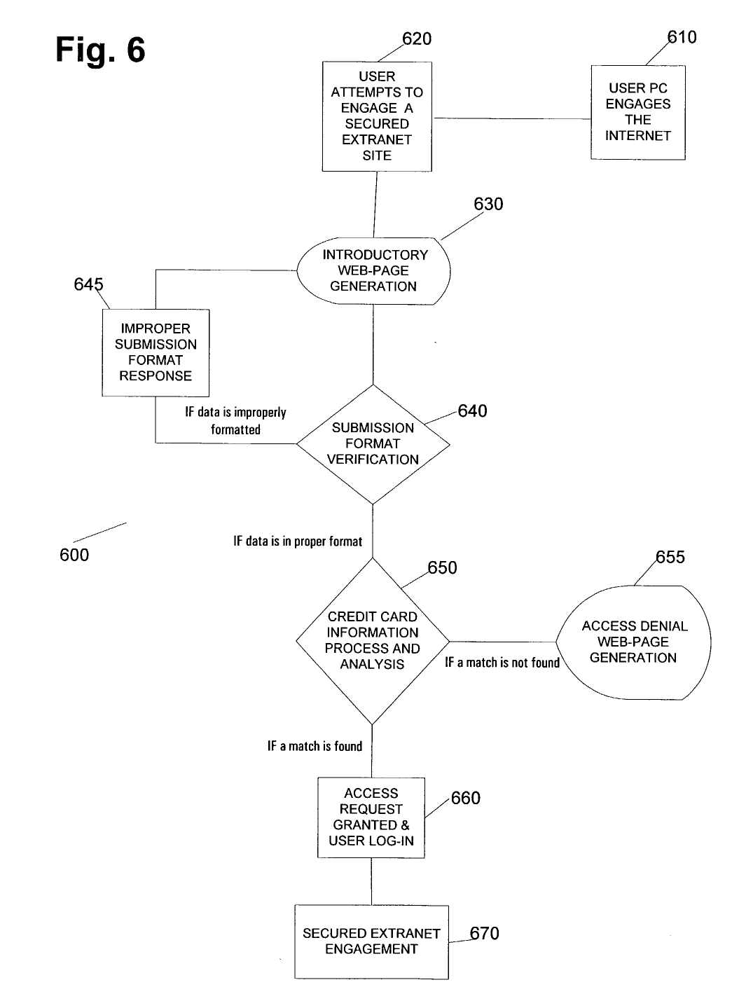

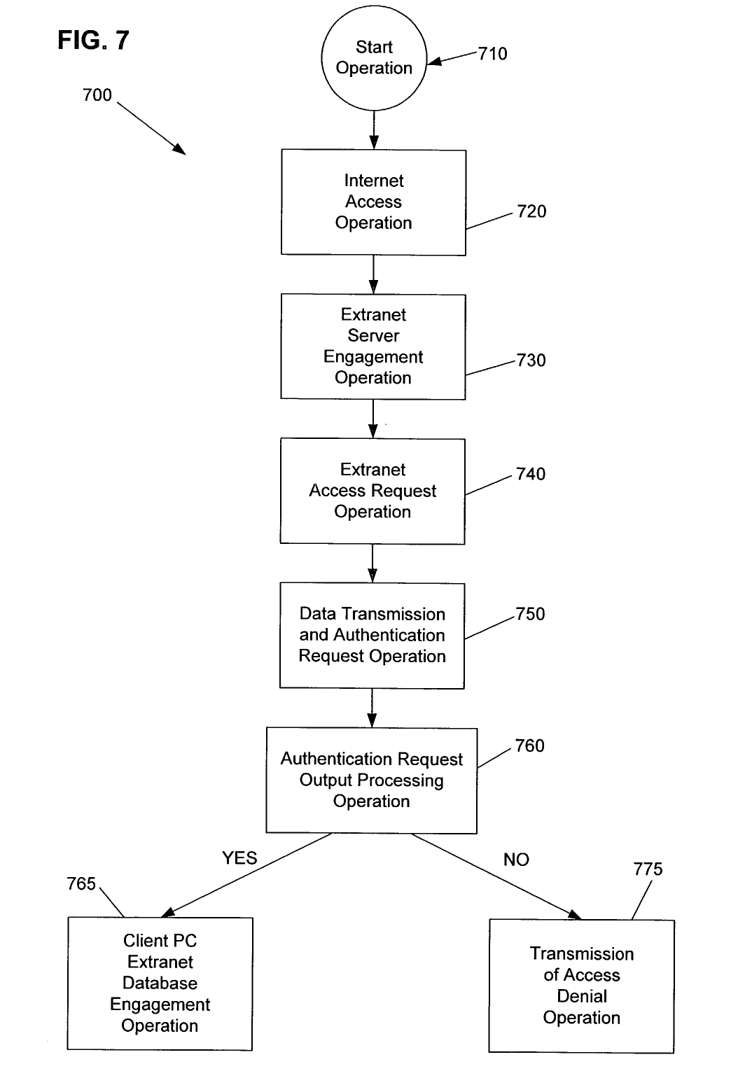

The secured transaction server 406 receives a submit operation 442. The Secured Transaction server 406 provides the submitted credit card number to an Extranet Security module 427 which immediately communicates with a third party supported, Credit Card Authorization Network 408. The network compares the submitted credit card number with its authorized credit card number database, then transmits the results back to the Extranet Security module 427. Based upon the results the Extranet Security module 427 determines whether the access request may proceed. More specifically, the Extranet Security module 427 receives the user's credit card number and processes the request to determine whether the user access may be authorized. A discussion of various embodiments of processes executed by the Extranet security module 427 is provided above with respect to FIGS. 1, 2 and 2a above and FIGS. 6-7 below. This processing, if successful, will ultimately result in permission being granted to the user requesting access to the secured Extranet site or database 429. For example, when permission is granted, the Extranet security module 427 will conduct further processing to specify where Extranet information transfer will occur. In an alternative embodiment, the Extranet security module 427 may require a user to engage this authorization process for each request for Extranet database 429. If the processing is unsuccessful (i.e., the credit card number does not match with any of the authorized credit card numbers), then user access will be denied. Thus, the Extranet security module 427 will direct additional web pages to user indicating a rejected request.

In one embodiment of the present invention, if the request may proceed, the Secured Transaction server 406 retrieves a first HTML web page specification, over data line 443, a web page indicating that the request has been authorized from the Host Web server's 402 over data line 444. The first HTML web page specification is located at an “accept URL” on the host web server 402. Thereafter, the user may engage the host-provided Extranet database 429. If a problem is encountered with the user submitted data, or the user credit card number, the request will not proceed. The secured transaction server 406 will retrieve, over data line 444, from the Host Web server's 402 Web Page Generating modules 451-454, over data line 444 a second HTML web page specification for a web page indicating the request has been declined. The second HTML web page specification is located at a “decline URL” on the host web server 402.

FIG. 5 illustrates a portion of an exemplary introduction web-page 500, with input fields, that is provided in an embodiment of an Extranet security system according to the present invention. In FIG. 5, an introductory web-page 500 is shown and it provides several different input fields for the user to use. In this exemplary introduction web-page 500, the input fields are identified by, and the user is prompted for information corresponding to, the identifying term disposed proximate to each input field. For illustrative purposes, the following input fields are shown: “FirstName” 510; “Last Name” 520; “E-mail Address” 530; “Credit Card #” 540; “Type Of Credit Card” 550; “Expiration Date” 560; “Street Address” 560; “Apartment/Suite #” 580; “City” 590; “State” 515; “Zip Code” 525; and “Name As It Appears On Credit Card” 530. The illustrated introductory web-page 500 also provides a submit button 545, that the user can engage or select (through the use of a variety of user manipulated input devices, such as a keyboard or a mouse) upon completion. As a result, the Extranet security system is notified that the user's access request information is ready to be processed. As discussed above with regard to previous figures, this introductory web-page 500 is generated by the Extranet request processing module to the user's PC, and the user provided information is received by the Extranet request processor module and then provided to the rest of the Extranet security system.

FIG. 6 illustrates an operational flow for one embodiment of an Extranet security system, according to the present invention. The processing begins when the user powers up a PC and engages the Internet 610 and the user attempts to visit a host Extranet site 620. In the introductory web-page generation stage 630, the Extranet request processing module will generate an introductory web-page that prompts the user for credit card information. The user will provide the requested credit card information by inputting the data into the input fields provided on the introductory web-page. Within the submission verification stage 640, the user's submitted credit card information is verified that it has been presented in the appropriate format (e.g., that all required fields have data in them, or that the credit card number size matches the type of credit card being used.). If the credit card information is not in proper format, in the improper submission format response stage 645 an error message is provided on a second web page generated by the Extranet request processing module, and the user will be redirected back to the introductory web-page generation stage 630. However, if the credit card information is in an acceptable format, then the credit card information process and analysis stage 650 is initiated. Within the credit card information process and verification stage 650, the credit card information is processed and compared against a current authorized-user database. If no match is found, the user's access request is denied, and in the access denial webpage generation stage 655 is initiated. Within this stage 655, a third web page is presented to the user indicating that the request has failed. On the other hand, if a match is found, then the user's access request is granted and the user is logged in, within the access request granted and log-in stage 680. Accordingly, the user is logged in according to predetermined unique user indicia provided amongst the user credit card information submitted (e.g., the user's credit card number). Finally, the user enters the secured Extranet engagement stage 670. At this stage, the user enjoys and can utilize a predetermined level of access to the secured Extranet.

FIG. 7 illustrates an operational flow diagram 700 from a client PC perspective, according to the present invention. The operational flow diagram 700 begins prior to the user accessing the Internet via a client PC at the Start operation 710. The user, through a client PC, accesses the Internet in the Internet access operation 720. The client PC engages the Extranet server in the Extranet Server Engagement operation 730. Once the client PC engages the Extranet server and seeks to access the secured Extranet database, control transfers to the Access Request operation 740. Within this operation 740, the user is then prompted for user credit card information. The client PC will receive, and display to the user an Access Request, web page (similar to that shown in FIG. 5), transmitted from the Extranet server, prompting the user to enter credit card information. Accordingly, a user who desires access to the secured Extranet database will enter their credit card information into the Access Request screen. When completed, the user selects, for example, a Submit icon on the web page and the information is then transmitted over the Internet, or other communication means, from client PC to the Extranet server.

After reception of the credit card information the Extranet server transfers control to the Data Transmission and Authentication Request operation 750. As part of this operation 750, the Extranet server transmits both the credit card information and a query as to whether the transmitted credit card information corresponds to an authorized member's credit card information. The Third Party server conducts an analysis of the credit card information submitted from the Extranet server, this includes comparing the submitted credit card number against authorized credit card numbers maintained on a credit card information database supported by the Third Party server. In one embodiment, the Extranet server's query is only directed at credit card number verification. After the third party server completes its authentication analysis it will communicate its result back to the Extranet server. Thereafter, control is passed to the Authentication Request Output processing operation 760. During this operation 760, the results of authentication analysis is received and evaluated within the Extranet server. If the evaluation of the analysis results yield a positive authentication of the credit card information (shown in FIG. 7 as “YES”), then control passes to the client PC-Extranet Database Engagement operation 765. Therein, the Extranet server grants the client PC access to its Extranet database. On the other hand, if the evaluation of the results yield a negative authentication (shown in FIG. 7 as “NO”), then control passes to the Transmission of Access Denial operation 775. Therein the client PC receives a message indicating a failed authentication and the Extranet server does not grant access to the client PC.

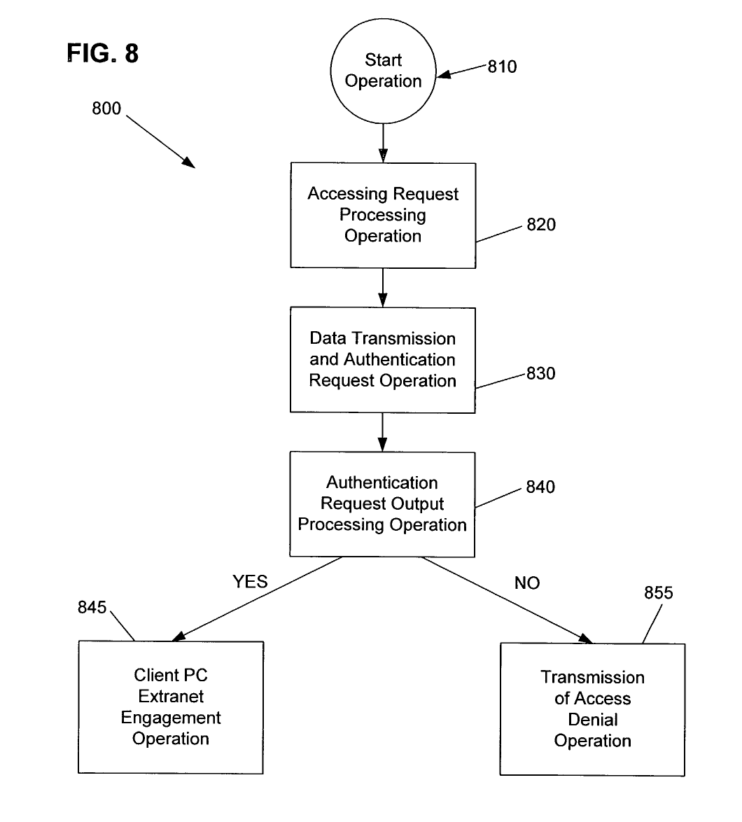

FIG. 8 illustrates an operational flow diagram 800 from the Extranet server perspective, according to the present invention. The flow diagram 800 begins prior to the user attempting to access the Internet in Start operation 810. The access request processing operation 820 is initiated once the user has encountered the Extranet provider web page and attempts to access the secured Extranet database. The Extranet server will transmit a web page (similar to the exemplary web page shown in FIG. 5) to the client PC. Thereby, requesting that the user enter the appropriate credit card information. Upon completion the user will submit the credit card information and control is passed to the Data Transmission and Authentication Request operation 830, wherein the credit card information is transmitted to the Extranet server. As part of this processing operation 830, the Extranet server transmits both the credit card information and a request for credit card information verification to a Third Party server for authentication and analysis. The Third Party server maintains authorized, member credit card information which includes authorized credit card numbers. In another embodiment, the request is only for credit card number verification.

After the Third Party server completes its authentication analysis it will communicate its the result back to the Extranet server. Thereafter, control is passed to the Authentication Request Output Processing operation 840. During this operation 840 the results of authentication analysis is received and evaluated by the Extranet server. If evaluation of the results yield a positive authentication (shown in FIG. 8 as “YES”), then control is passed to the Client PC-Extranet Engagement Operation 845. Therein, the Extranet server allows the Client PC to access the Extranet database. On the other hand, if the evaluation of the results yield a negative authentication (shown in FIG. 8 as “NO”), then control is transferred to the Transmission of Access Denial Operation 855. Therein, the Extranet server transmits a message indicating a failed authentication and does not grant Extranet database access to the Client PC.

Thus, the present invention is presently embodied as a method and a system for securely provide a desired level of access to restricted merchant web-sites utilizing the user's individual credit card data. While the invention has been particularly shown and described with reference to preferred embodiments thereof, it will be understood by those skilled in the art that various other changes in the form and details may be made therein without departing form the spirit and scope of the invention. The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of providing Extranet security to prevent unauthorized access to an Extranet site, the method comprising:
transmitting an introductory web page from an Extranet server to a user requesting access to the secure Extranet site, wherein at least one user-data input field is provided on the web page;
prompting the user to enter their credit card number within the at least one user-data input field;
transmitting the user-credit card number to an Extranet server which provides the credit card number to a security module, wherein the security module maintains a database of each of a plurality of predetermined authorized, user-credit card numbers;
verifying whether the submitted user credit card number is one of the plurality of predetermined authorized, user-credit card numbers, wherein said verifying step comprises comparing the user-credit card number with each of the plurality of predetermined authorized, user-credit card numbers; and
granting the user access to the secure Extranet site when a positive verification results from said verifying step, wherein an undesired output results in denial of access to said secure Extranet site.

2. The method of claim 1, wherein the security module is maintained on the Extranet server.

3. The method of claim 1, wherein the method further comprises verifying that each of the at least one input field contains data, wherein further if data is omitted from the at least one input field then a message indicating the omission is communicated to the user.

4. The method of claim 1, wherein further the method comprises tracking a level of access clearance associated with the authorized, user-credit card number.

5. The method of claim 1, wherein the granting step further comprises logging in the user to the Extranet site with the level of access clearance associated with the user-credit card number.

6. A method for providing heightened security to an Extranet site, thereby preventing unauthorized access, the method comprising:
transmitting, over an electronic medium, an introductory web page from an Extranet server to a user requesting access to the Extranet site;
prompting the user to enter requested personal information within the at least one user-data input field, wherein said personal information comprises the user's credit card related data;
transmitting the personal information provided by the user to a restricted web-site provider's transaction security processing server, wherein a database of characteristic personal information, uniquely associated with each of a plurality of predetermined authorized-users, is maintained, and wherein further said characteristic personal information comprises each of a plurality of predetermined authorized-users' credit card related data;
analyzing the personal information in view of the characteristic personal information uniquely associated with each of the plurality of predetermined authorized-users; and
granting access to a secured Extranet site when a desired output results from said analyzing step, wherein an undesired output results in denial of access to said secured Extranet site.

7. The method of claim 6, wherein transmitting over an electronic medium the introductory web page further comprises transmitting over an Internet.

8. The method of claim 6, wherein the plurality of predetermined authorized-users' credit card related data comprises a credit card number.

9. The method of claim 6, wherein the method further comprises verifying that each of the at least one input field contains data, wherein further if data is omitted from the at least one input field then a message indicating the omission is communicated to the user.

10. The method of claim 6, wherein further the method comprises tracking a level of access clearance associated with the user credit card number, wherein further, after granting access to a user, logging in the authorized-user into the Extranet site, with the level of access clearance associated with the user credit card number.

11. An Extranet security system for preventing unauthorized-users from gaining access to restricted web-sites, wherein the Extranet security system is maintained on an Extranet server, comprising:
a user interface module;
an Extranet request processing module, coupled to the user interface module, wherein an introductory web page is generated, that provides at least one input field, and wherein further a user is prompted to provide at least a user credit card number;
a credit card verification module, coupled to the Extranet request processing module wherefrom the user credit card number is communicated to a third party support server, wherein the user credit card number is processed and compared against an authorized-user credit card database maintained therein, wherein the results of the processing is communicated to the credit card verification module, wherein further if the comparison yields a desired output then the user is granted access to a secured Extranet, otherwise, user access is denied; and
an Extranet interface module coupled to the credit card verification module, whereby, after the credit card verification module grants the user access, the user engages an Extranet provider database maintained on the secured Extranet.

12. The system of claim 11, wherein the Extranet request processing module verifies that each of the at least one input field contains data, wherein further if data is omitted from the at least one input field then a message indicating the omission is communicated to the user.

13. The system of claim 11, wherein the system further comprises a rejected credit card tracking database, coupled to the credit card verification module, for storing rejected credit card numbers.

14. The system of claim 11, wherein the system further comprises a clearance level identification and association module, coupled to the credit card data verification module and the Extranet interface module, wherein said clearance level identification and association module tracks the level of access clearance associated with each authorized-user provided credit card number and communicates that level of access clearance to the credit card verification module, wherein further said module logs in the authorized-user with the secured Extranet in view of the level of access clearance associated with the user provided credit card number.
